(19) United States
(12) Patent Application Publication
(10) Pub. No.: US 2005/0257464 A1
(43) Pub. Date: Nov. 24, 2005

(54) Pergola end cap

(76) Inventor: Bryan S. Skulsky, Marshfield, MA (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 11/177,516

(22) Filed: Jul. 8, 2005

Related U.S. Application Data
(63) Continuation of application No. 11/010,163, filed on Dec. 10, 2004.
Application No. 11/010,163 is a division of application No. 10/364,447, filed on Feb. 11, 2003, now Pat. No. 6,829,862.
(60) Provisional application No. 60/356,521, filed on Feb. 13, 2002.

(51) Int. Cl. B29C 35/00

(52) U.S. Cl. 52/311.1

(57) ABSTRACT

A shaped, decorative pergola vinyl end cap and end piece, a method of shaping pergola vinyl component ends, and a portable tool used for shaping pergola vinyl component ends.

### RELATED U.S. APPLICATION DATA

This application is a continuation of U.S. application Ser. No. 11/010,163, filed Dec. 10, 2004, now pending, which is a divisional of U.S. application Ser. No. 10/364,447, filed Feb. 11, 2003, now U.S. Pat. No. 6,829,862, which claims the benefit of U.S. Provisional Application No. 60/356,521, filed Feb. 13, 2002.

### BACKGROUND OF THE INVENTION

This invention relates generally to pergolas, and more particularly to pergola end caps.

Prior art pergolas have generally been made from wood or metal. Wood and metal are adversely affected by weather, structurally and aesthetically deteriorating over time. To overcome the weather limitations of prior art materials, vinyl is becoming a popular substitute material. Vinyl provides the structural and aesthetic qualities of prior art materials with the added advantage of being nearly impervious to the effects of weather.

The vinyl components used in constructing pergola structures are pre-made rigid extrusions. Vinyl extrusions have generally hollow, rectangular shapes. End caps are required to finish protruding pergola ends. Prior art vinyl end caps have been flat pieces. Aesthetically, it is desirable to have shaped pergola ends, especially if decorative ends are desired in the pergola structure.

### SUMMARY OF THE INVENTION

The present invention provides a shaped, decorative pergola vinyl end cap, a method of shaping pergola vinyl component ends, and a portable tool used for shaping pergola vinyl component ends.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 is a rectangular vinyl extrusion before shaping;

FIG. 2 is a rectangular vinyl extrusion after shaping;

FIG. 3 is a perspective view, partly in section, of a pergola structure.

FIG. 4 is a perspective view of a template.

FIG. 5 is a perspective view of 2×6 and 2×8 pergola end caps.

FIG. 6 is a shaped rectangular vinyl extrusion end with pergola end cap applied.

FIG. 7 is a perspective view of a 2×8 pergola end cap.

FIG. 8 is a perspective view of a 2×6 pergola end cap.

FIG. 9 is a front view of a 2×6 pergola end cap.

FIG. 10 is a rear view of a 2×6 pergola end cap.

FIG. 11 is a side view of a 2×6 pergola end cap.

FIG. 12 is a bottom view of a 2×6 pergola end cap.

FIG. 13 is a top view of a 2×6 pergola end cap.

FIG. 14 is a rear view of a 2×8 pergola end cap.

FIG. 15 is a front view of a 2×8 pergola end cap.

FIG. 16 is a side view of a 2×8 pergola end cap.

FIG. 17 is a bottom view of a 2×8 pergola end cap.

FIG. 18 is a top view of a 2×8 pergola end cap.

FIG. 19 is a front perspective view of a shaped end piece.

FIG. 20 is a rear perspective view, partly in section, of a shaped end piece.

FIG. 21 is a front perspective view of the shaped end piece attached to an extrusion end.

FIG. 22 is a front perspective view of the shaped end piece attached to an extrusion end by means of tabs.

FIG. 23 is a front perspective view of the shaped end piece attached to an extrusion end by means of an external collar.

### DETAILED DESCRIPTION OF THE INVENTION

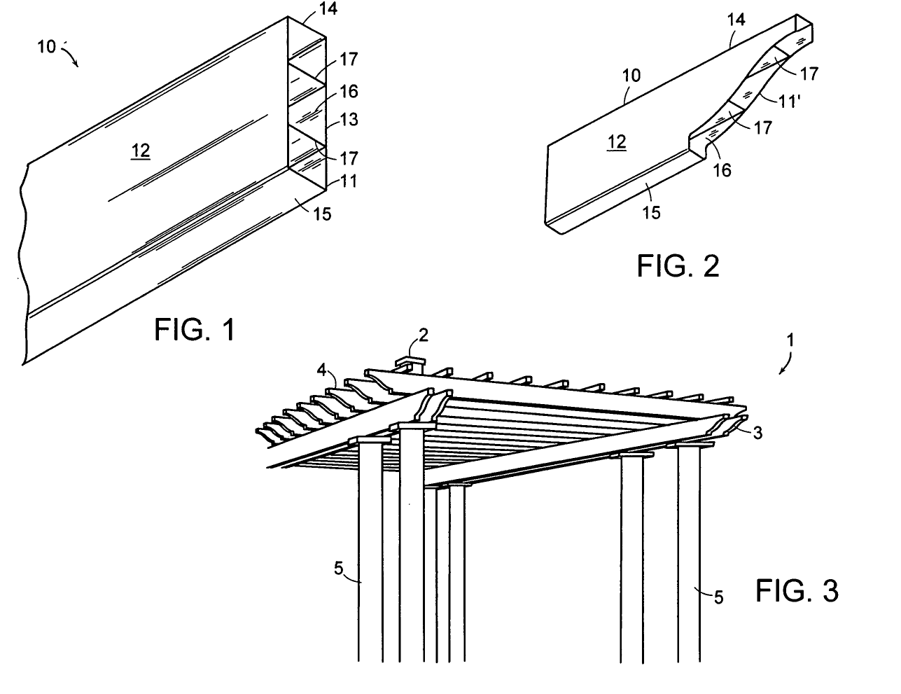

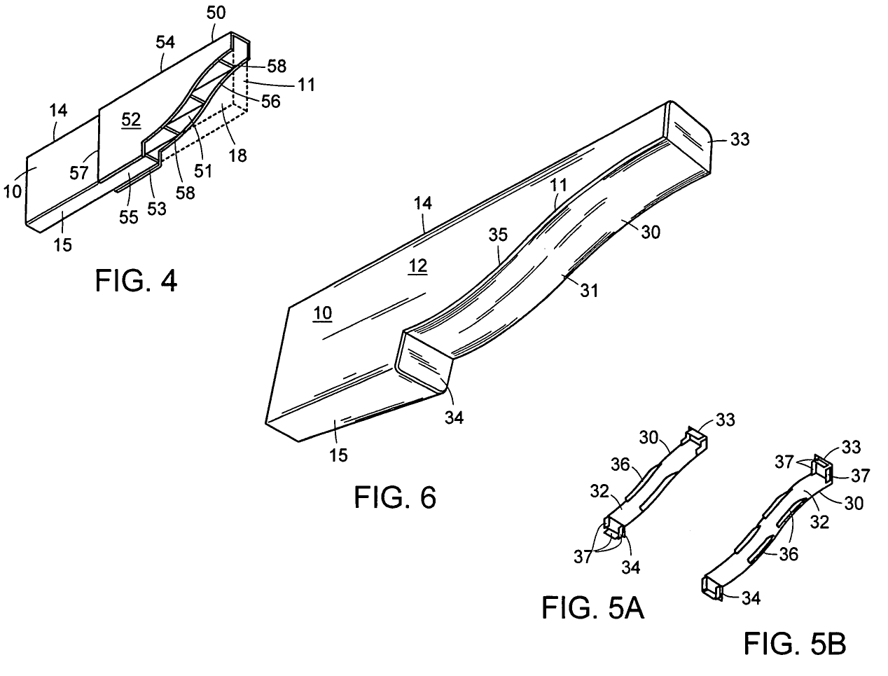

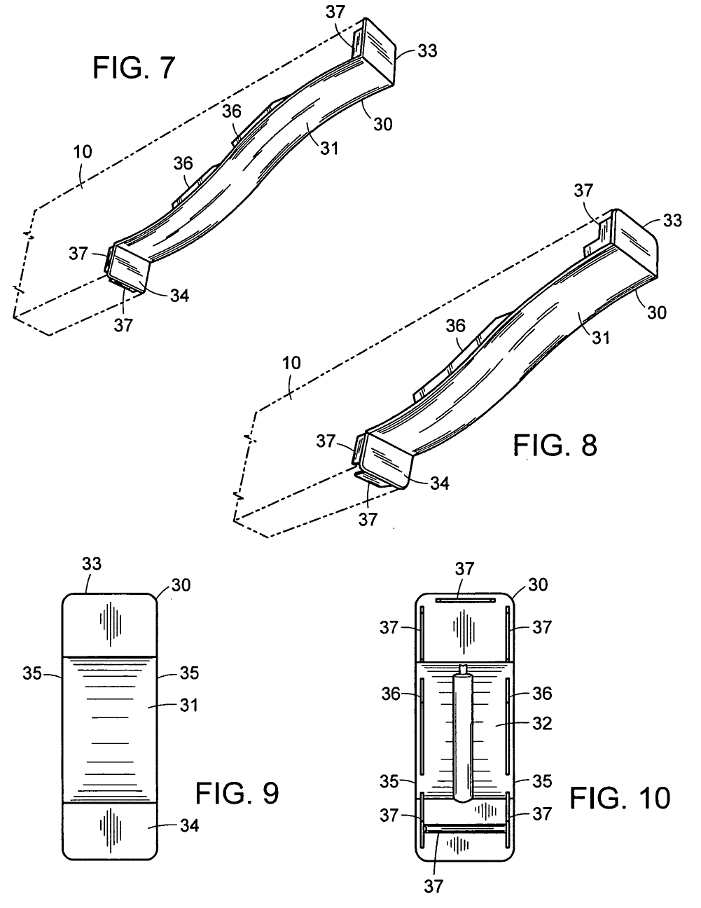

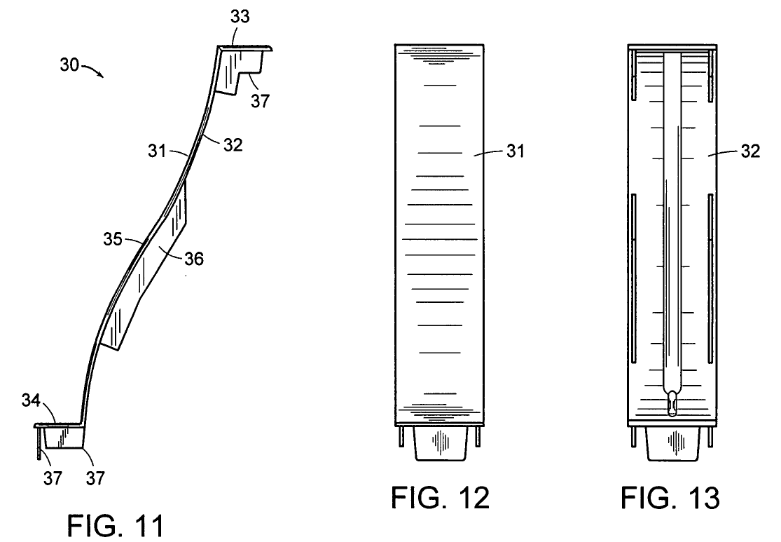

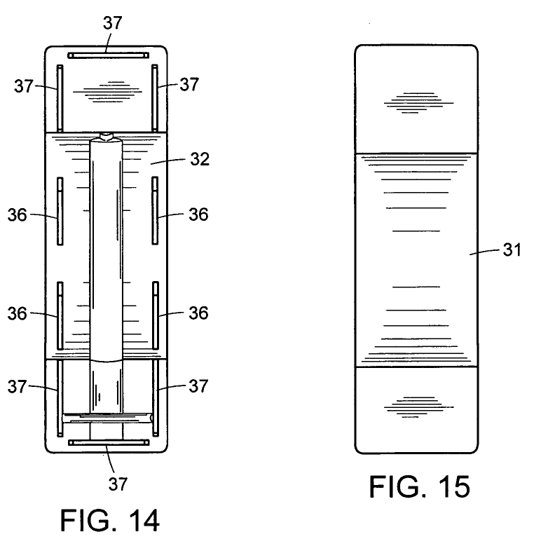

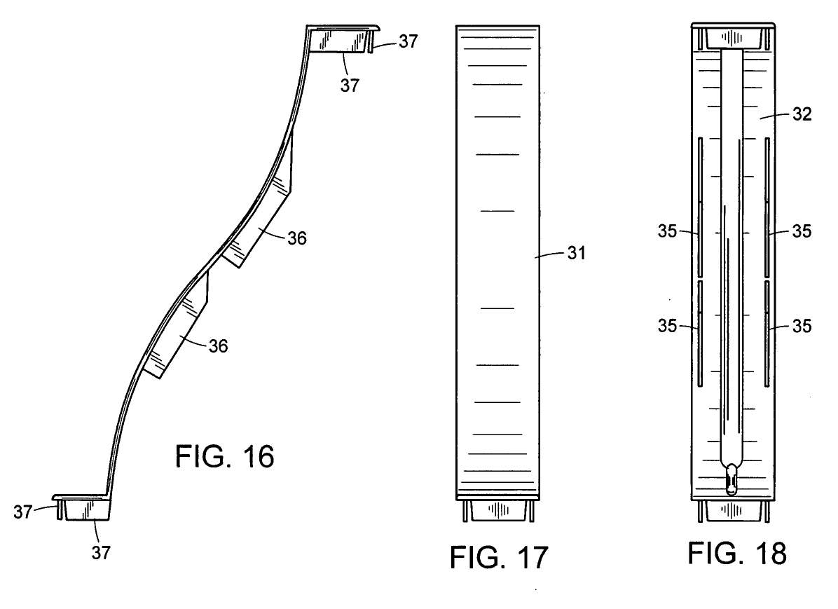

Referring to the drawings in detail wherein like elements are indicated by like numerals, there is shown a rectangular vinyl extrusion 10 before (FIG. 1) and after (FIG. 2) shaping. The extrusions 10 are major vinyl components used to form a pergola structure 1. Unlike wood, vinyl pergola elements must have their shapes assembled as opposed to simple mitering. A pergola is an arbor formed of horizontal trellis work supported on columns or posts. See FIG. 3. The pergola 1 has a trellis work “roof” 2 formed of horizontal carrying beams 3 and horizontal rafters 4. The beams 3 are supported by vertical posts 5. The beams 3 and rafters 4 are made from vinyl extrusions 10 with ends 11 which extend over the support posts 5 and carrying beams 3. The extrusion ends 11 are shaped prior to being formed into the pergola structure 1, typically by cutting with a CNC machine. Alternatively, a tool comprised of a template 50 may be fitted over the extrusion end 11 and the extrusion end 11 manually routed. See FIG. 4. A typical router used would be a laminate trimmer-style router with a collar or bearing able to follow the outline of the invention template. Each shaped extrusion end 11 then has an end cap 30 applied. See FIG. 5. Each end cap 30 is glued onto a shaped extrusion end 11. See FIG. 6. The end caps 30 may be preformed with a mold. Alternatively, a shaped end piece 60 as described in detail below may be preformed and then applied to an unshaped extrusion end 11.

Each extrusion 10 is comprised of a first side 12, an opposing second side 13, a top side 14 and a bottom side 15, said sides 12, 13, top side 14 and bottom side 15 defining an extrusion interior 16. The extrusion interior 16 has one or more internal bracing walls 17 perpendicularly joined to first side 12 and second side 13, said bracing walls 17 being parallel to said top side 14 and bottom side 15.

The invention template 50 has a first side 52, an opposing second side 53, a top side 54, an open bottom side 55, a forward, shaped end 56, and an open rear end 57, said sides 52, 53, top side 54, open bottom side 55, forward shaped end 56 and open rear end 57 defining a template interior 51. The template forward shaped end 56 may have side connectors 58, said side connectors being elongated, narrow elements connecting said first side 52 with said second side 53, thereby providing stiffening to the template 50. The template 50 is slid over the extrusion 10, template open rear end 57 over an extrusion end 11 first. The template 50 is then moved along the extrusion 10 until the top 54 of the template forward shaped end 56 is aligned with the top 14 of the extrusion end 11. The portion of the extrusion 10 protruding 18 forward of the template forward end 56 is then cut away. This results in an extrusion 10 with a shaped end 11′. See FIG. 2.

An invention end cap 30 is then applied to the shaped extrusion end 11′. For purposes of exposition, applicant assumes that two cross-sectional sizes of extrusions will be used, i.e., 2×6 and 2×8. A 2×6 extrusion will generally have two bracing walls 17 as shown in FIGS. 1 and 2. A 2×8 extrusion will generally have three bracing walls 17. Each end cap 30 has an outside, forward side 31, an inside, rear side 32, a top portion 33, a bottom portion 34, and two opposite side edges 35. Each side edge has one or more rearwardly protruding shaped side flanges 36. The end cap top portion 33 and bottom portion 34 each have a rectangular arrangement of rearwardly protruding flanges 37. The rearwardly protruding flanges 36, 37 are adapted to engage the interior portions of the extrusion sides 12, 13, top 14 and bottom 15. The flanges 36, 37 are arranged to fit between and around the bracing walls 17. Each end cap 30 is placed against a shaped extrusion end 11′ wherein the end cap inside, rear side 32 is positioned against the extrusion shaped end 11′ and the flanges 36 into the extrusion interior 17, said end cap top portion 33 abutting the extrusion top 14 and said end cap bottom 34 portion abutting the extrusion bottom 15.

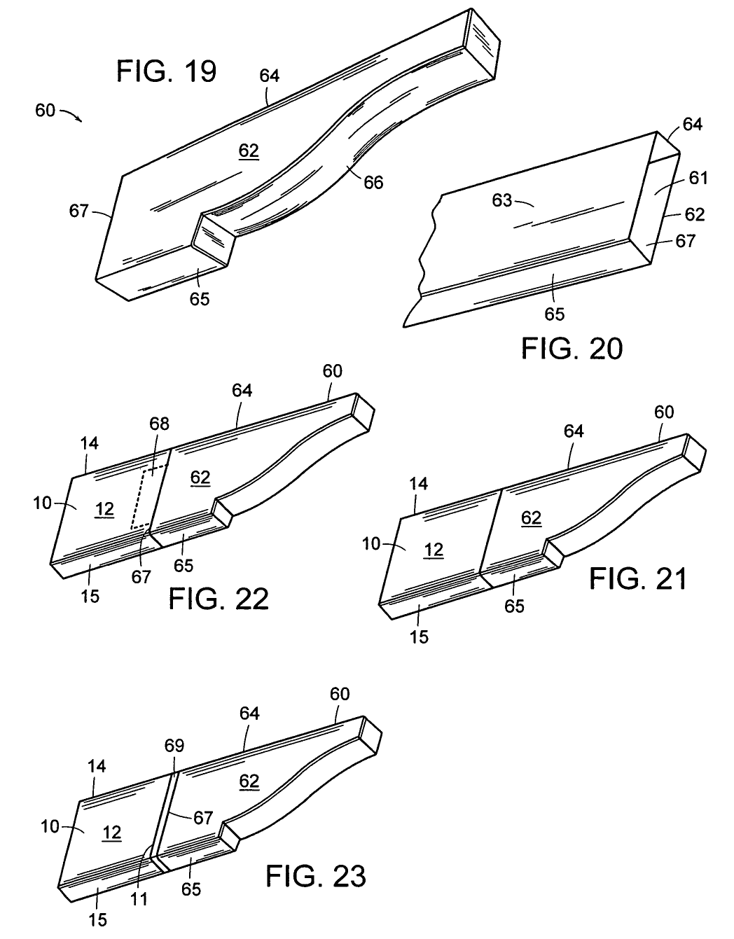

Referring more particularly to FIGS. 19-21, in an alternate embodiment, a shaped end piece 60 may be preformed and then applied to an unshaped extrusion end 11. The shaped end piece 60 has a first side 62, an opposing second side 63, a top side 64, a bottom side 65, a forward, closed, shaped end 66, and an open rear end 67, said sides 62, 63, top side 64, bottom side 65, forward shaped end 66 and open rear end 67 defining an end piece interior 61. The shaped end piece forward end 66 may be formed as described above with an end cap 30 applied. The shaped end piece open rear end 67 is fitted against and joined to an unshaped extrusion end 11 as shown in FIGS. 1 and 21. The shaped end piece 60 has a cross section dimensionally equal to the cross section of the extrusion 10.

The shaped end piece 60 may be glued to the extrusion end 11 by means of tabs 68 protruding from the shaped rear end into the extrusion end interior 16. See FIG. 22. The heavy duty glue used fuses the vinyl pieces, i.e., extrusion 10 and shaped end piece 60, together. Alternatively, the shaped end piece 60 may be joined to the extrusion end 11 by means of an external collar 69 fitted about the seam formed by the extrusion end 11 and shaped end piece rear 67. See FIG. 23.

It is understood that the above-described embodiment is merely illustrative of the application. Other embodiments may be readily devised by those skilled in the art which will embody the principles of the invention and fall within the spirit and scope thereof.

1. A pergola end cap to provide a shaped end appearance for an elongated rectangular extrusion of a pergola structure, the extrusion having opposing ends and extending in a longitudinal direction, the pergola end cap comprising:
an end cap body that is constructed and arranged to be mounted to an end of the extrusion, the end cap body including a top end portion, a bottom end portion and a forward side that extends from the top end portion to the bottom end portion, each of the top end portion, the bottom end portion and the forward side having an outer surface that faces outwardly in the longitudinal direction when the end cap is mounted to the end thereof, the outer surfaces of the top end portion and the bottom end portion being parallel to each other and offset from each other in the longitudinal direction.

2. The pergola end cap according to claim 1, wherein the outer surfaces of the top end portion and the bottom end portion are perpendicular to the longitudinal direction.

3. The pergola end cap according to claim 1, wherein the forward side has a width defined by opposing edges thereof that corresponds to the outer width of the extrusion.

4. The pergola end cap according to claim 1, further comprising a flange protruding rearwardly from the end cap body, the flange being constructed and arranged to engage a wall at the end of the extrusion to mount the end cap thereto.

5. The pergola end cap according to claim 1, wherein the outer surface of the forward side has a curved shape in a direction from an upper end thereof to a lower end thereof to provide the shaped end appearance.

6. A pergola end cap to provide a shaped end appearance for an elongated rectangular extrusion of a pergola structure, the extrusion having opposing ends and extending in a longitudinal direction, the extrusion having an outer width, the pergola end cap comprising:
an end cap body that is constructed and arranged to be mounted to an end of the extrusion, the end cap body including a shaped forward side that faces outwardly in the longitudinal direction when the end cap is mounted thereto, the forward side having a width that corresponds to the outer width of the extrusion, the width of the forward side defined by opposing edges thereof, the opposing edges having a curved shape in the longitudinal direction from an upper end of the forward side toward a lower end of the forward side.

7. The pergola end cap according to claim 6, wherein the end cap body further includes a top end portion and a bottom end portion, the forward side extending from the top end portion to the bottom end portion.

8. The pergola end cap according to claim 7, wherein each of the top end portion and the bottom end portion includes an outer surface that faces outwardly in the longitudinal direction when the end cap is mounted thereto, the outer surfaces being parallel to each other.

9. The pergola end cap according to claim 8, wherein the outer surfaces of the top end portion and the bottom end portion are offset from each other in the longitudinal direction.

10. The pergola end cap according to claim 9, wherein the outer surfaces of the top end portion and the bottom end portion are perpendicular to the longitudinal direction.

11. The pergola end cap according to claim 6, further comprising a flange protruding rearwardly from the end cap body, the flange being constructed and arranged to engage a wall at the end of the extrusion to mount the end cap thereto.

12. A pergola comprising:
a plurality of elongated rectangular extrusions that form a trellis roof of the pergola, each extrusion being generally hollow from one end to an opposite end thereof and extending in a longitudinal direction, an end of each extrusion being closed with a shaped end cap that includes a forward side that faces outwardly in the longitudinal direction, the forward side having a curved shape in a direction from an upper end thereof toward a lower end thereof that provides the extrusion with a shaped end appearance.

13. The pergola according to claim 12, wherein the end cap further includes a top end portion and a bottom end portion, the forward side extending from the top end portion to the bottom end portion.

14. The pergola according to claim 13, wherein each of the top end portion and the bottom end portion includes an outer surface that faces outwardly in the longitudinal direction, the outer surfaces being parallel to each other.

15. The pergola according to claim 13, wherein each of the top end portion and the bottom end portion includes an outer surface that faces outwardly in the longitudinal direction, the outer surfaces being offset from each other in the longitudinal direction.

16. The pergola according to claim 15, wherein the outer surfaces of the top end portion and the bottom end portion are perpendicular to the longitudinal direction.

17. The pergola according to claim 12, wherein each extrusion has an outer width and the forward side has a width defined by opposing edges thereof that corresponds to the outer width of the extrusion.

18. The pergola according to claim 12, wherein the end cap further includes a flange protruding rearwardly which engages a wall at the end of the extrusion to mount the end cap thereto.

19. A method of fabricating a pergola that includes a trellis roof constructed with a plurality of elongated rectangular extrusions, each extrusion being generally hollow from one end to an opposite end thereof and extending in a longitudinal direction, each extrusion having an outer width, the method comprising acts of:
attaching a shaped end cap to an end of each extrusion, the end cap including a forward side that faces outwardly in the longitudinal direction, the forward side having a width that dimensionally corresponds to the outer width of the extrusion and having a curved shape that provides the extrusion with a shaped end appearance.

20. The method according to claim 19, wherein the end cap further includes a top end portion and a bottom end portion, the forward side extending from the top end portion to the bottom end portion.

21. The method according to claim 20, wherein each of the top end portion and the bottom end portion includes an outer surface that faces outwardly in the longitudinal direction, the outer surfaces of the top end portion and the bottom end portion being parallel to each other.

22. The method according to claim 21, wherein the outer surfaces of the top end portion and the bottom end portion are offset from each other in the longitudinal direction.

23. The method according to claim 22, wherein the outer surfaces of the top end portion and the bottom end portion are perpendicular to the longitudinal direction.

24. The method according to claim 19, wherein the end cap further includes a flange protruding rearwardly from the end cap, the method further comprising an act of engaging the flange to a wall at the end of the extrusion to attach the end cap thereto.
